(19) United States
(12) Patent Application Publication
(10) Pub. No.: US 2015/0094898 A1
(43) Pub. Date: Apr. 2, 2015

(54) VEHICLE AUTONOMOUS MODE DEACTIVATION

(71) Applicant: Ford Global Technologies, LLC, Dearborn, MI (US)

(72) Inventors: Levasseur Tellis, Southfield, MI (US); Timothy D. Zwicky, Dearborn, MI (US)

(73) Assignee: Ford Global Technologies, LLC, Dearborn, MI (US)

(21) Appl. No.: 14/043,820

(22) Filed: Oct. 1, 2013

(51) Int. Cl. B60W 40/12

(52) U.S. Cl. CPC B60W 40/12
USPC 701/23

(57) ABSTRACT

A vehicle system includes an autonomous mode controller configured to control at least one vehicle subsystem when operating in an autonomous mode and a processing device configured to monitor a vehicle condition, compare the vehicle condition to a parameter defined by a maintenance schedule, and disable the autonomous mode when the vehicle condition exceeds the parameter and until the vehicle condition is reset. A method includes monitoring a vehicle condition while a vehicle is operating in an autonomous mode, comparing the vehicle condition to a parameter defined by a maintenance schedule, and disabling the autonomous mode when the vehicle condition exceeds the parameter and until the vehicle condition is reset.

### BACKGROUND

Drivers perform many actions while operating a motor vehicle. Drivers are expected to identify objects within and near the roadway, predict what those objects might do in the near future, decide upon a best course of action based on the prediction, and execute the decided-upon action. Autonomous vehicles seek to relieve the driver of such responsibilities. There may be times, however, when it is appropriate for the driver to resume control of the vehicle.

### BRIEF DESCRIPTION OF THE DRAWINGS

FIG. 1 illustrates an exemplary vehicle system for deactivating an autonomous driving mode under certain circumstances.

FIG. 2 illustrates a flowchart of an exemplary process that may be implemented by the system of FIG. 1.

### DETAILED DESCRIPTION

An exemplary vehicle system includes an autonomous mode controller that controls at least one vehicle subsystem when operating in an autonomous mode and a processing device that monitors a vehicle condition, compares the vehicle condition to a parameter defined by a maintenance schedule, and disables the autonomous mode when the vehicle condition exceeds the parameter and until the vehicle condition is reset. The processing device, therefore, prevents the vehicle from operating in the autonomous mode until a certified technician has inspected the vehicle.

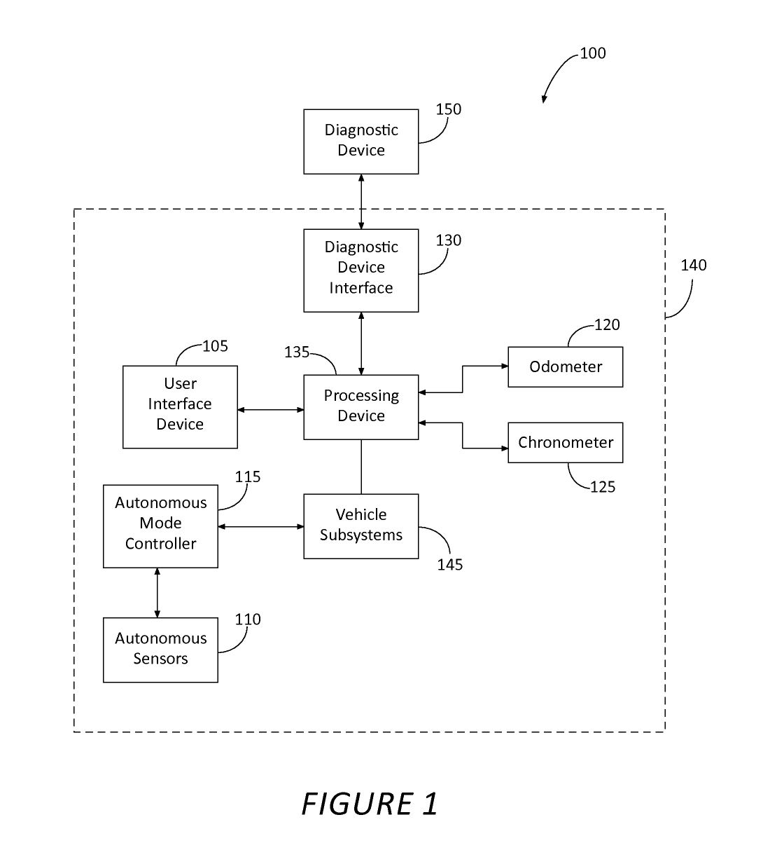

FIG. 1 illustrates an exemplary system 100 that may take many different forms and include multiple and/or alternate components and facilities. While an exemplary system is shown, the exemplary components illustrated are not intended to be limiting. Indeed, additional or alternative components and/or implementations may be used.

As illustrated, the system 100 includes a user interface device 105, one or more autonomous sensors 110, an autonomous mode controller 115, an odometer 120, a chronometer 125, a diagnostic device interface 130, and a processing device 135. The system 100 may be incorporated into any vehicle 140 configured to operate in an autonomous (i.e., driverless) mode.

The user interface device 105 may be configured to present information to a user, such as a driver, during operation of the vehicle 140. Moreover, the user interface device 105 may be configured to receive user inputs. Thus, the user interface device 105 may be located in a passenger compartment of the vehicle 140. In some possible approaches, the user interface device 105 may include a touch-sensitive display screen. The user interface device 105 may further be configured to generate an audible alarm, a visual alarm, or both.

The autonomous sensors 110 may include any number of devices configured to generate signals that help navigate the vehicle 140 while operating in an autonomous mode. Examples of autonomous sensors 110 may include a radar sensor, a lidar sensor, a camera, or the like. The autonomous sensors 110 help the vehicle 140 “see” the roadway and/or various obstacles while the vehicle 140 is operating in the autonomous mode.

The autonomous mode controller 115 may be configured to control one or more subsystems 145 while the vehicle 140 is operating in the autonomous mode. Examples of subsystems 145 that may be controlled by the autonomous mode controller 115 may include a brake subsystem, a suspension subsystem, a steering subsystem, and a powertrain subsystem. The autonomous mode controller 115 may control any one or more of these subsystems 145 by outputting signals to control units associated with these subsystems 145.

The odometer 120 may be configured to measure the distance traveled by the vehicle 140 and output signals representing the distances measured. The odometer 120 may measure the distance mechanically or calculate the distance from, e.g., the speed of the engine, the transmission, or the wheels. In some possible implementations, the odometer 120 may include a navigation device, such as a Global Positioning System (GPS) device, configured to triangulate the distance.

The chronometer 125 may be configured to measure an amount of time that has elapsed and output a corresponding signal. The chronometer 125 may measure time according to the Coordinated Universal Time (UTC) standard or any other standard for measuring time. In some possible approaches, the signal output by the chronometer 125 may represent a current time following the UTC standard. The signal output by the chronometer 125 may alternatively represent that a particular amount of time has elapsed. That is, by way of example only, there chronometer 125 may output the signal after, e.g., 500 hours has elapsed since the chronometer 125 began marking time.

The diagnostic device interface 130 may be configured to facilitate communication between the vehicle 140 (e.g., one or more vehicle subsystems 145) and a diagnostic device 150. The diagnostic device 150 may be configured to request vehicle data using a code such as an on-board diagnostics parameter identification (OBD-II PID) code. The diagnostic device interface 130 may transmit the code to one or more vehicle subsystems 145 over a communication bus (not shown). The vehicle subsystem 145 with the requested information may respond to the diagnostic device 150 via the diagnostic device interface 130. The diagnostic device 150 can display the requested information to a technician. In some possible implementations, the technician may, using the diagnostic device 150, provide information to one or more vehicle subsystems 145 or to the processing device 135. For example, the diagnostic device 150 may be used to update one or more vehicle settings.

The processing device 135 may be configured to communicate with other components in the vehicle 140 and execute various processes. For example, the processing device 135 may be configured to monitor a vehicle condition. The vehicle condition may include the status of one or more of the vehicle subsystems 145, the distance the vehicle 140 is traveled, and/or the amount of time the vehicle 140 has spent driving. As discussed in further detail below, the processing device 135 may be configured to compare any number of monitored vehicle conditions to one or more parameters defined by a maintenance schedule. The parameters may define, based on mileage or time, when certain vehicle subsystems 145 or the vehicle 140 as a whole are due for inspection by a certified technician. Using the vehicle condition, the processing device 135 may determine that inspection is required for at least one vehicle subsystem 145. Moreover, the processing device 135 may prevent the vehicle 140 from entering the autonomous mode until the inspection occurs. In other words, the processing device 135 may be configured to disable the autonomous mode when the vehicle condition exceeds the parameter and until the vehicle condition is corrected (when the vehicle condition is the result of a subsystem 145 failure) or reset (when the vehicle condition is based on time or mileage).

As mentioned above, the vehicle condition may include a distance traveled, an amount of elapsed time, or both. When considering distance, the processing device 135 may be configured to compare the distance traveled to the parameter that defines a maximum allowable distance for the vehicle 140 to operate before service or inspection of the vehicle 140 is required.

In some possible implementations, the processing device 135 may only compare the distance traveled while the vehicle 140 is operating in the autonomous mode. Therefore, the processing device 135 may be configured to separate the distance into a first distance representing a distance traveled in the autonomous mode and a second distance representing the distance traveled in a non-autonomous mode. In this approach, the processing device 135 may be configured to disable the autonomous mode if the first distance exceeds the maximum allowable distance defined by the parameter. The distance traveled, including the first distance and the second distance, may be determined or measured from signals generated by the odometer 120.

When considering time, the processing device 135 may compare the amount of elapsed time to a maximum amount of time, defined by the parameter, before service or inspection of the vehicle 140 is required. The processing device 135 may, in some instances, compare the time the vehicle 140 is traveling in the autonomous mode to the parameter. Thus, the processing device 135 may be configured to separate the amount of elapsed time into a first elapsed time representing the amount of elapsed time the vehicle 140 has spent in the autonomous mode and the second elapsed time representing the amount of elapsed time the vehicle 140 has spent in the non-autonomous mode. The processing device 135 may, in this example, only compare the first elapsed time to the parameter defining the maximum amount of time and disable the autonomous mode if the first elapsed time exceeds the maximum amount of time. The amount of elapsed time, including the first elapsed time and the second elapsed time, may be determined or measured from signals generated by the chronometer 125.

Before the processing device 135 disables the autonomous mode, the processing device 135 may, via the user interface device 105, prompt the driver to assume control of the vehicle 140. Once the processing device 135 has determined that the driver has assumed control of the vehicle 140, the processing device 135 may disable the autonomous mode to allow the driver to fully operate the vehicle 140. The processing device 135 may determine that the driver has assumed control based on a user input provided by the driver to the user interface device 105.

After a technician has inspected the vehicle 140 and concluded that the vehicle 140 may be operated in the autonomous mode, the processing device 135 may re-enable the autonomous mode. The technician may, using the diagnostic device 150, transmit a reset command to the processing device 135 via the diagnostic device interface 130. Upon receipt of the reset command, the processing device 135 may reset a counter or other frame of reference associated with the distance traveled, the amount of elapsed time, or both.

In general, computing systems and/or devices, such as the autonomous mode controller 115, the processing device 135, and the diagnostic device 150, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

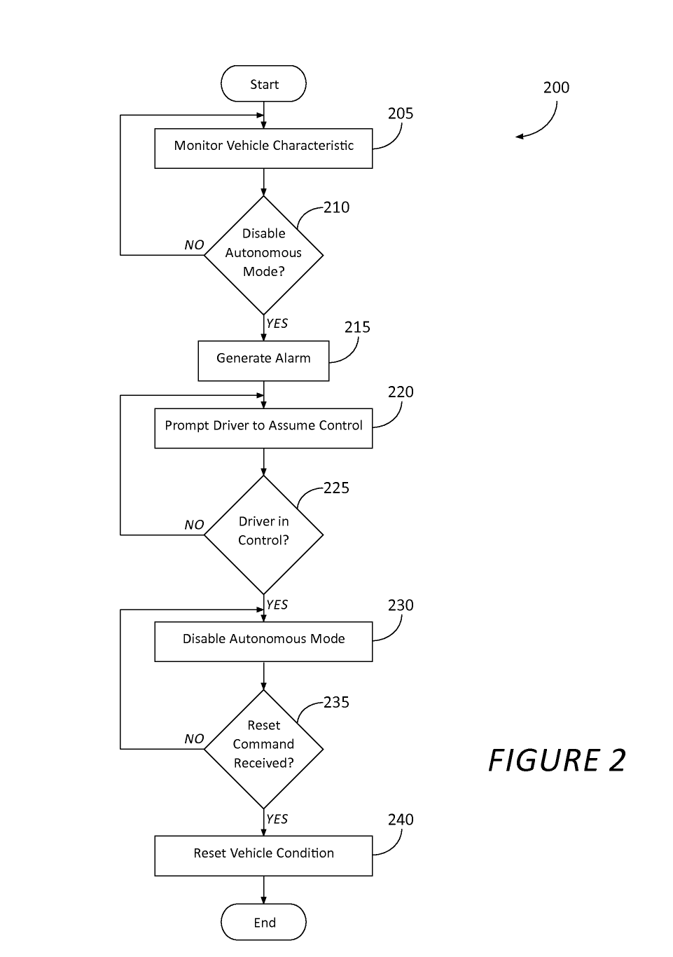

FIG. 2 is a flowchart of an exemplary process 200 that may be implemented by the processing device 135 to prevent the vehicle 140 from operating in the autonomous mode.

At block 205, the processing device 135 may monitor one or more vehicle conditions. Examples of vehicle conditions may include the status of one or more vehicle subsystems 145, the distance traveled by the vehicle 140 while in the autonomous mode, or the amount of time the vehicle 140 has been operated in the autonomous mode. The distance traveled and/or the amount of time may be measured relative to a reference frame. For instance, the distance and/or time may be measured from when the vehicle 140 was manufactured, purchased, or last serviced or inspected.

At decision block 210, the processing device 135 may determine whether to disable the autonomous mode. To do so, the processing device 135 may compare the vehicle condition monitored at block 205 to one or more parameters defined by the maintenance schedule. For example, the processing device 135 may compare a distance traveled to the parameter that defines the maximum allowable distance since, e.g., the previous inspection that the vehicle 140 may travel in the autonomous mode before another inspection is required. Alternatively or in addition, the processing device 135 may compare the elapsed time to the parameter that defines the maximum amount of time since, e.g., the previous inspection that the vehicle 140 may travel in the autonomous mode before another inspection is required. If one or more vehicle conditions do not exceed the respective parameters, the process 200 may return to block 205. If one or more vehicle conditions exceed the respective parameters, the process 200 may continue at block 215.

At block 215, the processing device 135 may generate an alarm. The alarm may include an audible alarm, a visual alarm, or both. The purpose of the alarm may be to warn the driver that the autonomous mode will be disabled due to the vehicle conditions identified at block 205. The alarm may be presented to the driver via the user interface device 105.

At block 220, the processing device 135 may prompt the driver to resume control of the vehicle 140. The prompt may be presented to the driver via, e.g., the user interface device 105. In some instances, the processing device 135 may further provide information to the driver that explains why the autonomous mode will be disabled and instructs the user to assume control of the vehicle 140.

At decision block 225, the processing device 135 may determine whether the driver has assumed control of the vehicle 140. For example, the processing device 135 may receive via the user interface device 105 a user input indicating that the driver has agreed and is ready to assume control of the vehicle 140. If the processing device 135 is unable to determine whether the driver has assumed control the vehicle 140 or if the processing device 135 has not yet received the user input, the process 200 may return to block 220. Once the processing device 135 has determined that the driver has assumed control of the vehicle 140, the process 200 may continue at block 230.

At block 230, the processing device 135 may disable the autonomous mode. For example, the processing device 135 may prevent the autonomous mode controller 115 from controlling one or more vehicle subsystems 145. Moreover, the processing device 135 may prevent the user interface device 105 from accepting any user input commanding the vehicle 140 to operate in the autonomous mode. Once disabled, the processing device 135 may present information to the driver via the user interface device 105 explaining why the autonomous mode has been disabled. The information may further include instructions for re-enabling the autonomous mode. For instance, the instructions may explain that an inspection by a certified technician must be performed before the autonomous mode can be re-enabled.

At decision block 235, the processing device 135 may determine whether a reset command has been received. The reset command, as discussed above, may be received from a diagnostic device 150 and indicate that a certified technician has performed the inspection required to re-enable the autonomous mode. If the reset command is received at block 235, the process 200 may continue at block 240. Otherwise, decision block 235 may be repeated until the reset command is received.

At block 240, the processing device 135 may reset the vehicle condition. In some possible implementations, resetting the vehicle condition may include redefining a reference frame for the distance traveled or amount of time that has elapsed since the previous inspection. With the vehicle conditions reset, autonomous mode may be re-enabled. That is, the processing device 135 may permit the user interface device 105 to receive a command from the driver to operate the vehicle 140 in the autonomous mode.

The process 200 may end or repeat after block 240.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
an autonomous mode controller configured to control at least one vehicle subsystem when operating in an autonomous mode;
a processing device configured to monitor a vehicle condition, compare the vehicle condition to a parameter defined by a maintenance schedule, and disable the autonomous mode when the vehicle condition exceeds the parameter and until the vehicle condition is reset.

2. The vehicle system of claim 1, wherein the vehicle condition includes a distance traveled and the parameter includes a maximum allowable distance.

3. The vehicle system of claim 2, wherein the distance traveled includes a first distance representing a distance traveled in the autonomous mode and a second distance representing a distance traveled in a non-autonomous mode, and wherein the processing device is configured to disable the autonomous mode if the first distance exceeds the maximum allowable distance.

4. The vehicle system of claim 2, further comprising an odometer configured to measure the distance traveled and output a distance signal representing the measured distance traveled to the processing device.

5. The vehicle system of claim 1, wherein the vehicle condition includes an elapsed time and the parameter defines a maximum amount of time.

6. The vehicle system of claim 5, wherein the elapsed time includes a first elapsed time representing an elapsed time in the autonomous mode and a second elapsed time representing an elapsed time in a non-autonomous mode, and wherein the processing device is configured to disable the autonomous mode if the first elapsed time exceeds the maximum amount of time.

7. The vehicle system of claim 5, further comprising a chronometer configured to measure the elapsed time and output a signal representing the elapsed time to the processing device.

8. The vehicle system of claim 1, wherein the processing device is configured to enable the autonomous mode after receiving a reset command.

9. The vehicle system of claim 1, wherein the processing device is configured to prompt a driver to assume control before disabling the autonomous mode.

10. A method comprising:
monitoring a vehicle condition while a vehicle is operating in an autonomous mode;
comparing the vehicle condition to a parameter defined by a maintenance schedule; and
disabling the autonomous mode when the vehicle condition exceeds the parameter and until the vehicle condition is reset.

11. The method of claim 10, wherein the vehicle condition includes a distance traveled and the parameter includes a maximum allowable distance.

12. The method of claim 11, wherein the distance traveled includes a first distance representing a distance traveled in the autonomous mode and a second distance representing a distance traveled in a non-autonomous mode, and wherein the autonomous mode is disabled if the first distance exceeds the maximum allowable distance.

13. The method of claim 10, wherein the vehicle condition includes an elapsed time and the parameter defines a maximum amount of time.

14. The method of claim 13, wherein the elapsed time includes a first elapsed time representing an elapsed time in the autonomous mode and a second elapsed time representing an elapsed time in a non-autonomous mode, and wherein the autonomous mode is disabled if the first elapsed time exceeds the maximum amount of time.

15. The method of claim 10, further comprising:
receiving a reset command; and
resetting the vehicle condition after receiving the reset command.

16. The method of claim 10, further comprising prompting a driver to assume control of the vehicle.

17. The method of claim 16, wherein the autonomous mode is disabled only after the driver has assumed control of the vehicle.

18. A non-transitory computer-readable medium tangibly embodying computer-executable instructions that cause a processor to execute operations comprising:
monitoring a vehicle condition while a vehicle is operating in an autonomous mode;
comparing the vehicle condition to a parameter defined by a maintenance schedule; and
disabling the autonomous mode when the vehicle condition exceeds the parameter and until the vehicle condition is reset.

19. The non-transitory computer-readable medium of claim 18, wherein the vehicle condition includes a distance traveled and the parameter includes a maximum allowable distance.

20. The non-transitory computer-readable medium of claim 18, wherein the vehicle condition includes an elapsed time and the parameter defines a maximum amount of time.
